(19) United States
(12) Patent Application Publication
(10) Pub. No.: US 2013/0125009 A1
(43) Pub. Date: May 16, 2013

(54) REMOTE DESKTOP LOCALIZED CONTENT SHARING

(71) Applicants: Lisa Seacat DeLuca, San Francisco, CA (US); Soobaek Jang, Hamden, CT (US); Daniel C. Krook, Fairfield, CT (US)

(72) Inventors: Lisa Seacat DeLuca, San Francisco, CA (US); Soobaek Jang, Hamden, CT (US); Daniel C. Krook, Fairfield, CT (US)

(73) Assignee: INTERNATIONAL BUSINESS MACHINES CORPORATION, Armonk, NY (US)

(21) Appl. No.: 13/297,805

(22) Filed: Nov. 16, 2011

(51) Int. Cl. G06F 3/01; G06F 15/16

(52) U.S. Cl. 715/740

(57) ABSTRACT

Illustrative embodiments disclose managing content displayed in a remote data processing system by identifying a set of links displayed in the content of the remote data processing system during a desktop sharing session between a local data processing system and the remote data processing system. The local data processing system obtains information about the set of links identified. Responsive to a selection of a link in the set of links displayed on the remote data processing system during the desktop sharing session, the local data processing system retrieving content using the link on the local data processing system using the information obtained about the set of links.

### 1. FIELD

The disclosure relates generally to accessing a remote data processing system and more specifically to processing links displayed on the remote data processing system.

### 2. DESCRIPTION OF THE RELATED ART

When interacting with a remote computer system using a desktop sharing tool, using links on the remote desktop can be difficult. Clicking on a link in the shared desktop environment causes the remote computer to open the link and access the information on the remote computer rather than the local computer. This can be problematic, since the remote computer may attempt to open a link using a software application the remote machine does not have installed, resulting in an error. For example, a user of a local computer running Lotus Notes® may click on a Lotus Notes® link in a remote computer that does not have Lotus Notes® installed. The remote computer attempts to open the link using Lotus Notes®, but, since the remote computer does not have Lotus Notes® installed, an error occurs.

A user may desire to use a link that is on a remote computer in the computer system he is using rather than on the remote computer system. For example, a user may desire to use a link he sees on a desktop sharing tool on the local computer instead of on the remote computer.

Therefore, it would be advantageous to have a method and apparatus that takes into account at least some of the issues discussed above, as well as possibly other issues.

### SUMMARY

Illustrative embodiments disclose managing content displayed in a remote data processing system by identifying a set of links displayed in the content of the remote data processing system during a desktop sharing session between a local data processing system and the remote data processing system. The local data processing system obtains information about the set of links identified. Responsive to a selection of a link in the set of links displayed on the remote data processing system during the desktop sharing session, the local data processing system retrieves content using the link on the local data processing system using the information obtained about the set of links.

### BRIEF DESCRIPTION OF THE SEVERAL VIEWS OF THE DRAWINGS

FIG. 1 is an illustration of a block diagram of a desktop sharing environment in accordance with an illustrative embodiment;

FIG. 2 is an illustration of computer displays of a remote desktop sharing session in accordance with an illustrative embodiment;

FIG. 3 is an illustration of a flowchart of a local desktop sharing tool process on a local computer system in accordance with an illustrative embodiment;

FIG. 4 is an illustration of a flowchart of a remote tool process on a remote computer system in accordance with an illustrative embodiment;

FIG. 5 is an illustration of a flowchart of an action confirmation process implemented during a desktop sharing session on a local computer system in accordance with an illustrative embodiment;

FIG. 6 is an illustration of a flowchart of an action confirmation process implemented during a desktop sharing session on a remote computer system in accordance with an illustrative embodiment;

FIG. 7 is an illustration of a data structure used in by a desktop sharing tool during a desktop sharing session in accordance with an illustrative embodiment; and

FIG. 8 is an illustration of a block diagram of a data processing system in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible computer readable medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

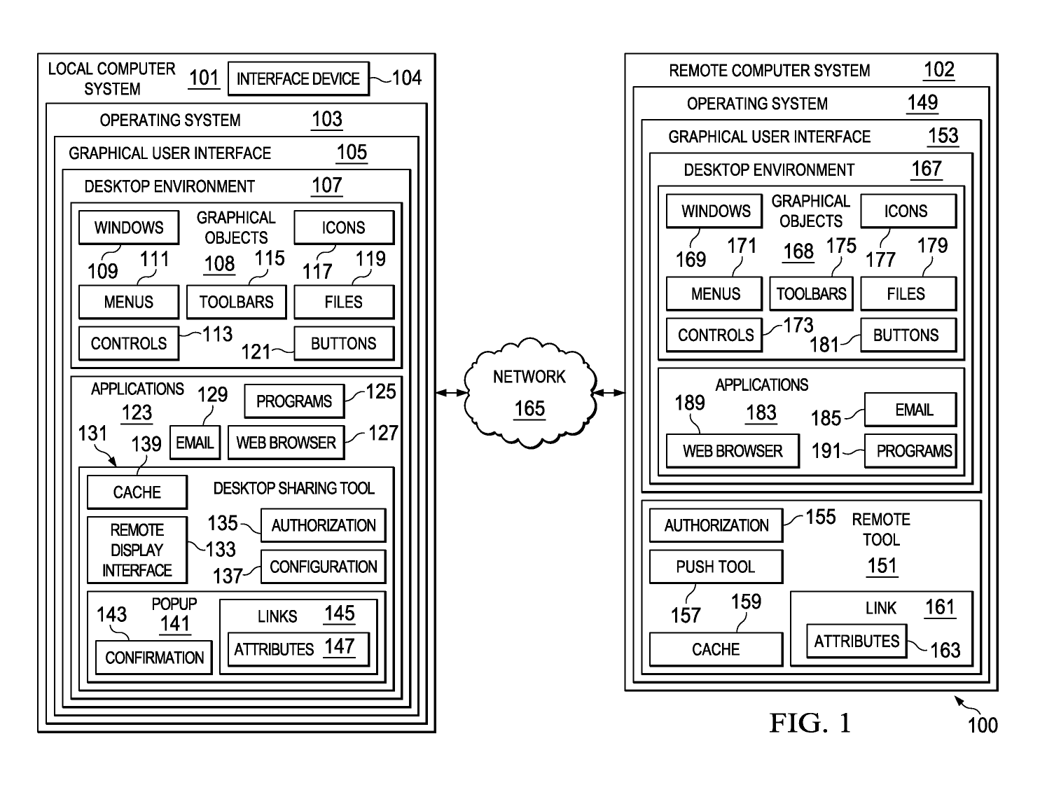

Turning now to FIG. 1, an illustration of a block diagram of a desktop sharing environment is depicted in accordance with an illustrative embodiment. It should be appreciated that FIG. 1 is only provided as an illustration of one implementation and is not intended to imply any limitation with regard to the environment in which different embodiments may be implemented. Many modifications to the depicted environment may be made.

As depicted, desktop sharing environment 100 includes local computer system 101 and remote computer system 102. As depicted, local computer system 101 includes operating system 103, which can be accessed by clicks using interface device 104, such as, for example, a computer mouse, touchscreen, trackball, pointing stick, touchpad, or keyboard. As used herein, “computer system” means any type of data processing system, such as, for example, a computer, laptop, notebook, mobile phone, or tablet. As used herein “operating system” means a set of programs for managing computer hardware resources and application software. Examples of operating system 103 include Linux®, Android®, iOS®, MAC OS X®, Microsoft Windows®, and any other system for managing computer hardware resources and application software. As depicted, operating system 103 includes graphical user interface 105, such as commonly encountered in a Windows® or MAC OS X® environment, and typically react to a clickable input from interface device 104 on local computer system 101 to receive command and control user inputs. As used herein “set of” means one or more.

As depicted, graphical user interface 105 comprises desktop environment 107. As defined and used herein, desktop environment 107 refers to a style of graphical user interface (GUI) 105 derived from a metaphor to a desktop seen on most modern personal computers allowing a user to easily access, configure, and modify features of operating system 103. As depicted, desktop environment 107 consists of graphical objects 108 including windows 109, menus 111, controls 113, toolbars 115, icons 117, files 119, and buttons 121. As depicted, desktop environment 107 also includes applications 123. As depicted, applications 123 include programs 125, web browser 127, email 129, and desktop sharing tool 131. Desktop sharing tool 131, in an illustrative example, includes remote display interface 133, authorization 137, cache 139, and popup 141. As depicted, popup 141 includes confirmation 143, links 145 and attributes 147. “Links” as used herein means a hyperlink referencing to a document, file, a website, or a document within a file or a website. The user can click on links 145 using interface device 104 to access or open the link. Links 145 can open whole documents, files, or websites, or open to a specific element within a document, file, or website. Links 145 can appear as alphanumeric text, pictograms or icons, buttons, or pictures. Links 145 are often used to implement reference mechanisms, such as, for example, tables of contents, footnotes, bibliographies, indexes, letters, glossaries, websites, or files. Displayed links 145 include, for example, associated attributes 147, which can include, for example, data for a hyperlink, type, link location, universal resource locator indicator, identification reference data, media description, language code, link state, access key, alternative text, tab index, pane information, and browser.

As depicted, remote computer system 102 includes operating system 149. Examples of operating system 149 include Linux®, Android®, iOS®, MAC OS X®, Microsoft Windows®, and any other system for managing computer hardware resources and application software. As depicted, operating system 149 includes remote tool 151 and graphical user interface 153. Remote user tool 151, in this illustrative example, includes authorization 155, push tool 157, cache 159, and link 161. As depicted, link 161 also includes attributes 163.

In these illustrative examples, graphical user interface 153 receives input from a user interface device, such as interface device 104 associated with local computer system 101 to receive command and control user inputs. As depicted, graphical user interface 153 comprises desktop environment 167. As defined and used herein, desktop environment 167 refers to graphical user interface (GUI) 153 allowing a user to access, process, and configure features of operating system 149. As depicted, desktop environment 167 consists of graphical objects 168 and applications 183.

In these illustrative examples, network 165 connects local computer system 101 with remote computer system 102. Network 165 supports communication between local computer system 101 and remote computer system 102. In these illustrative examples, a user of local computer system 101 establishes a communication link over network 165 to remote computer system 102 using desktop sharing tool 131 for interacting with desktop environment 167 using remote tool 151. Desktop sharing tool 131 and remote tool 151 exchange authentication and encryption data to ensure a user of local computer system 101 possesses authority for establishing a remote desktop sharing session with remote computer system 102, and desktop sharing tool 131 and remote tool 151 establish the remote desktop sharing session between local computer system 101 and remote computer system 102. Session sharing 135 and session sharing 155 facilitate the desktop sharing session between local computing system 101 and remote computing system 102, respectively, so desktop sharing tool 131 can access and control remote computer system 102 through desktop environment 167.

In this illustrative example, desktop sharing tool 131 uses remote tool 151 to access graphical objects 168 and applications 183 on the remote computer system 102, so that the remote computer system 102 receives inputs through the interface provided by windows 169 using menus 171, controls 173, toolbars 175, icons 177, and buttons 181. Files 179, programs 191, email 185, and web browser 189 can be opened and used with windows 169 controlled with remote tool 151. Programs 125 and programs 191 can include, for example, productivity programs, such as word processors, spreadsheets, accounting, publishing, computer aided designs, graphics design, and computer animation programs, as well as any other productivity program operated by the desktop environment 167. Programs 125 and programs 191 may also, for example, include entertainment programs, such as for example, games, and multimedia players configured to stream movies, television, and radio program media. As depicted, during a remote desktop sharing session establishing sharing session 135 and session sharing 155, a user of local computer system 101 can access and control desktop environment 167 using desktop sharing tool 131 operating with remote tool 151 to access graphical objects 168 and applications 183 and remotely control remote computer system 102. Links 161 and their attributes 163 can be sent to local computer system 101 using push tool 157 to send the data or pulling data from the window 169 using scraping techniques to capture and retrieve the data. Remote tool 151 can be similarly used to capture and send data associated with menus 171, controls 173, toolbars 175, icons 177, files 179, and buttons 181 as desktop sharing tool pulls data from desktop environment 167.

As depicted, menus 111 and menus 171 list commands presented to a user by the respective local computer system 101 or remote computer system 102. As depicted, controls 113 and controls 173 displays an information arrangement, such as a window or text box, changeable by the user to provide an interaction point for manipulating a given kind of data. As depicted, toolbars 115 and toolbars 175 include multiple on-screen buttons, icons, menus, or other input or output elements arranged in a row. Applications 123 and applications 183 often include toolbars to input commands. As depicted, icons 117 and icons 177 comprise pictograms used to navigate within local computer system 101 and remote computer system 102. The pictogram provides a small picture or symbol serving as a quick, intuitive representation of a software tool, function, or data file. The pictogram operates as an electronic hyperlink or file shortcut to access application 123 or application 183 or data, i.e. files 179, allowing a user to easily and intuitively navigate operating system 103 and operating system 149 respectively. As depicted, buttons 121 and buttons 181 provide the user with a simple way to input a command, like starting a query at a search engine, or to interact with dialog boxes, such as to confirm an action. Typically, buttons 121 and buttons 181 appear as rectangles or rounded rectangle objects with a descriptive caption or pictogram in the center. As depicted, menus 111 and menus 171, controls 113 and controls 173, toolbars 115 and toolbars 175, icons 117 and icons 177, files 119 and files 179, and buttons 121 and buttons 181 displayed on the graphical user interface 105 and graphical user interface 153 are activated, i.e., clicked on using interface device 104, so the user can navigate directly into and out of the identified function without knowing anything further about the location or requirements. It should be noted that in these illustrative examples, remote computer system 102 does not require a powered display. Rather, the data for graphical interface 153 can be obtained by accessing remote computer system 102 memory or auxiliary port output for visual data for graphical user interface 153 using desktop sharing tool 131.

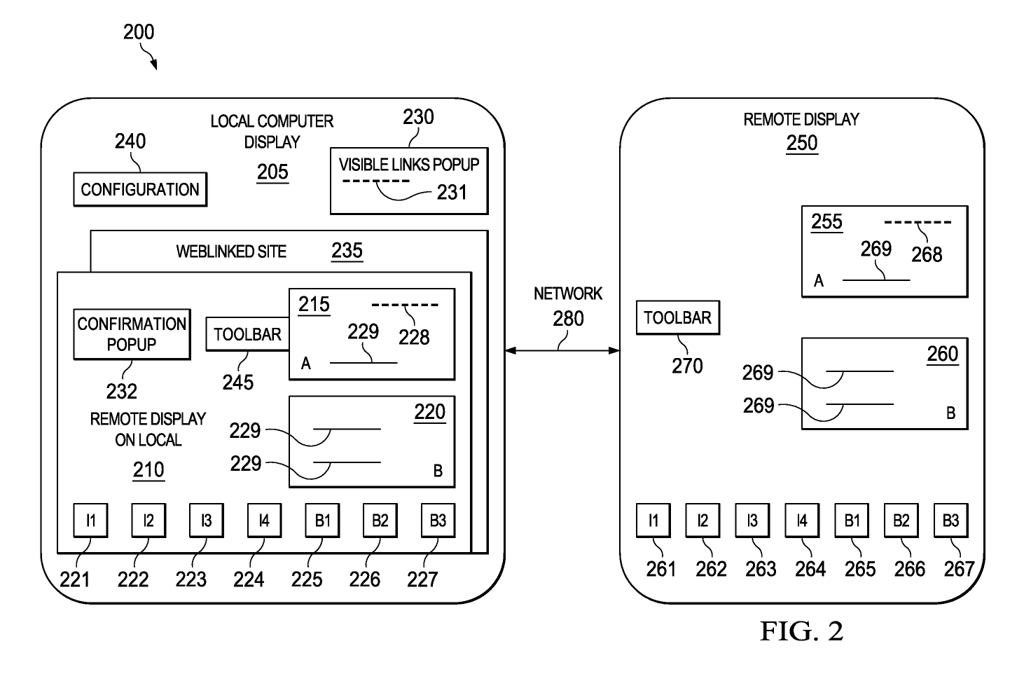

Turning now to FIG. 2, an illustration of computer displays during a remote desktop sharing session in accordance with an illustrative embodiment is depicted. It should be appreciated that FIG. 2 is only provided as an illustration of one implementation and is not intended to imply any limitation with regard to the computer displays in which different embodiments may be implemented. Many modifications to the depicted computer displays may be made.

As depicted, local computer display 205 includes a number of features providing visual data and control interfaces to a user of local computer system 101 of FIG. 1. As depicted, remote display 250 displays graphical user interface 183 of FIG. 1 on local computer display 205. In these illustrative embodiments, window A 215 displays visible links 228 available in window 215 as well as non-link data 229, and window B 220 displays non-link data 229. As depicted, links 228 and non-link data 229 can take the form of alphanumeric text, pictures, images, icons, or buttons. As depicted, icon I1 221, icon I2 222, icon I3 223, and icon I4 224 on remote display 250 can provide a clickable link appearing as a pictogram providing an intuitive representation of a software tool, a function, or a data file accessible on remote computer system 102 to access the software tool, a function, or a data file using interface device 104 with the desktop sharing tool 131 of FIG. 1. As depicted, button B1 225, button B2 226, and button B3 227 provide a clickable link to input a command, like starting a query at a search engine, or to interact with dialog boxes, like confirming an action.

As depicted, visible links popup 230 displays links 231, which comprise identical access as links 228 visible in window A 215. However, in these illustrative examples the appearance of links 231 can differ from links 228, as links 231 can be a display of other attributes 147 of FIG. 1 associated with link 228, such as, for example a hypertext, an address, a file location, pictogram, or button. In some illustrative examples, visible links popup 230 can also include one or more icons 221, 222, 223, and 224 or one or more buttons 225, 226, and 227. In these illustrative examples, visible links popup 230 is cleared and re-populated with links visible on remote display on local 210 in either window A 215 or window B 220 as depicted. In other illustrative examples, visible links popup 230 can show a list of all links that become visible during the desktop sharing session. In other illustrative examples, the visible links popup window 230 can be eliminated, and link attributes copied to an accessible list in cache 139 of FIG. 1 that can selectively be opened by a user. In yet other illustrative examples, links 228 can be displayed anywhere on local computer display 205. As depicted, confirmation popup 232 can comprise a query to confirm execution of a link on local computer system 101 or remote computer system 102, or provide a selection input of local computer system 101 or remote computer system 102 of FIG. 1 to execute link 228. As depicted, weblinked site 235 comprises an Internet website opened with link 231 or some other link no longer visible in visible links popup 230 or window A 215. The user of local computer system 101 of FIG. 1 can freely navigate and interact with the opened website accessed by the desktop sharing tool 131 of FIG. 1. However, this is one illustrative example only. Link 231 can open a multitude of resources such as, for example, a document, a file, an application, a browser, an email, a message, or any other resource

As depicted, toolbar 245 may also be visible in remote display on local 210. In this illustrative example, toolbar 245 comprises multiple on-screen buttons, icons, menus, or other input or output elements arranged in a row, which provide quick, intuitive visual pictograms used to navigate within remote computer system 102 of FIG. 1 to access a software tool, function, or data file or provide a simple way to input a command, like starting a query at a search engine, or to interact with dialog boxes, like confirming an action. In some illustrative examples, toolbar 245 can be active allowing operation by the user in situ, or actively copied into the visible links popup window 230, or inactive.

As depicted, remote computer display 250 on remote computer system 102 provides graphical user interface 153 to remote computer system 102 of FIG. 1. However, in these illustrative examples, remote computer display 250 does not represent what is actually visible on a powered display of remote computer system 102, but rather represents data for graphical user interface 153 obtained by accessing remote computer system 102 memory or auxiliary port output for visual data to supply to graphical user interface 153 using desktop sharing tool 131.

As depicted, remote computer display 250 features essentially the same data elements found in remote display 250. As depicted, window A 255 displays visible links 268 available in window 255 as well as non-link data 269, and window B 260 displays non-link data 269. As depicted, links 268 and non-link data 269 can take the form of alphanumeric text, images, pictures, icons, or buttons. As depicted, icon I1 261, icon I2 262, icon I3 263, and icon I4 264 on remote computer display 250 can provide a clickable link appearing as a pictogram providing an intuitive representation of a software tool, a function, or a data file accessible on remote computer system 102 to access the software tool, a function, or a data file using interface device 104 with the desktop sharing tool 131 of FIG. 1. As depicted, button B1 265, button B2 266, and button B3 267 provide a clickable link to input a command, like starting a query at a search engine, or to interact with dialog boxes, like confirming an action. As depicted, toolbar 245 may also be visible in remote display 250. As depicted, toolbar 270 comprises multiple on-screen buttons, icons, menus, or other input or output elements arranged in a row, which provide quick, intuitive visual pictograms used to navigate within remote computer system 102 of FIG. 1 to access a software tool, function, or data file or provide a simple way to input a command, like starting a query at a search engine, or to interact with dialog boxes, like confirming an action.

As depicted, network 280 provides a communication link between local computer system 101 and remote computer system 102. In this illustrative example, a user establishes a secure communication link over network 280 to exchange encryption and authentication keys and passwords to establish secure communications for session sharing 135 and session sharing 155. Desktop sharing tool 131 can then interact with remote tool 151 to access and control operating system 149 of FIG. 1 with desktop environment 167.

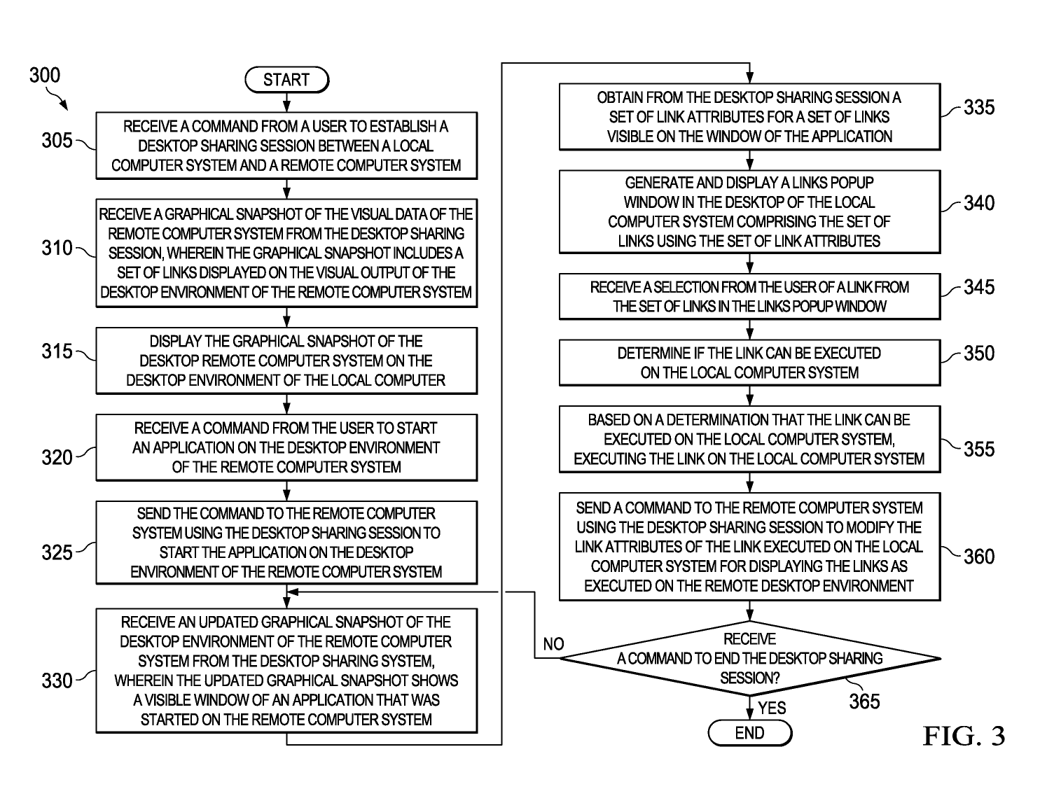

FIG. 3 depicts an illustration of a flowchart of a local desktop sharing tool process on a local computer system in accordance with an illustrative embodiment. It should be appreciated that FIG. 3 is only provided as an illustration of one implementation and is not intended to imply any limitation with regard to the local desktop sharing tool process in which different embodiments may be implemented. Many modifications to the depicted local desktop sharing tool process may be made.

As depicted, local desktop sharing tool process on local computer system 300 can be implemented as desktop sharing tool 131 on FIG. 1. With references to elements in FIG. 1, as depicted, the process begins with local computer system 101 receiving a command from a user to establish a desktop sharing session between local computer system 101 and remote computer system 102 (step 305). In this illustrative example, establishing sharing session 135 and 155 provides secure communication for desktop sharing tool 131 to interact with remote tool 151.

As depicted, local computer system 101 receives a graphical snapshot of the visual data of the remote computer system from the desktop sharing session, wherein the graphical snapshot includes a set of links displayed on the visual output of the desktop environment 167 of remote computer system 102 (step 310). In this illustrative example, the graphical snapshot originates from the memory or auxiliary port output for visual data on remote computer system 102. As depicted at step 315, local computer system 101 displays the graphical snapshot of the desktop environment 167 of remote computer system 102 on desktop environment 107 of local computer system 101 (step 320).

As depicted, local computer system 101 sends the command to remote computer system 102 using the desktop sharing session to open the application on desktop environment of remote computer system 102 (step 325). As depicted, local computer system 101 receives an updated graphical snapshot of desktop environment 167 of the remote computer system 102 from the desktop sharing system, wherein the updated graphical snapshot shows a visible window of an application that was started on the remote computer system 102 (step 330). As depicted in step 335, local computer system 101 obtains from the desktop sharing session a set of link attributes 147 for a set of links 145 visible on the window of the application. In these illustrative examples, attributes 147 can be obtained by local computer system 101 pulling attribute data from remote computer system 102 or obtained by remote computer system 102 pushing attributes 147 to local computer system 101. As depicted, local computer system 101 generates and displays a links popup 141 window in the desktop environment 107 of the local computer system 101 comprising the set of links using the set the set of link attributes 147 (step 340).

As depicted in step 345, local computer system 101 receives a selection from the user of a link 161 from the set of links 145 in the links popup 141 window. In these illustrative examples, the set of links 145 comprises attributes 147 displayed as, for example, a hypertext of alphanumeric test, an icon, a picture, or a button, and can include, for example, a location on a network, a memory location, a website address, a universal resource locator, document name, website name, file name, or alternate text. As depicted, local computer system 101 determines if the link 161 can be executed on the local computer system 101 (step 350). As depicted, based on a determination that the link 161 can be executed on the local computer system 101, executing the link 161 on the local computer system 101 (step 355). As depicted, local computer system 101 sends a command to the remote computer system 102 using the desktop sharing session to modify the link attributes 163 of the link 161 executed on the local computer system 101 for displaying the link 161 as executed on the remote desktop environment 167 (step 360). In step 365, as depicted, the local computer system 101 can receive a command to end the desktop sharing session. If a user ends the session, the process ends, but if the user does not input a command to end the session, the process proceeds to step 330 to receive an updated graphical snapshot.

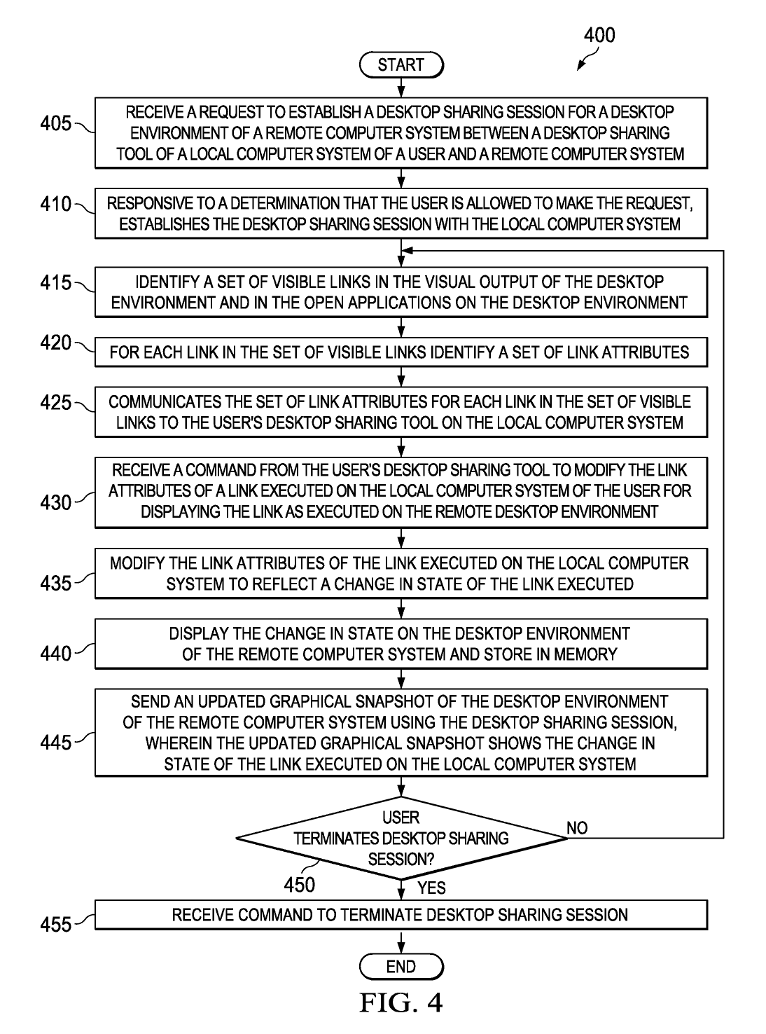

Turning now to FIG. 4, an illustration of a flowchart of a remote tool process on a remote computer system in accordance with an illustrative embodiment is depicted. It should be appreciated that FIG. 4 is only provided as an illustration of one implementation and is not intended to imply any limitation with regard to the remote tool process in which different embodiments may be implemented. Many modifications to the depicted remote tool process may be made.

As depicted, remote tool process on remote computer system 400 can be implemented as remote tool 151 on FIG. 1. With references to elements in FIG. 1, as depicted, the process begins when remote computer system 102 receives a request to establish a desktop sharing session for a desktop environment 167 of remote computer system 102 between desktop sharing tool 131 of a local computer system 101 of a user and the remote computer system 102 (step 405). Next, as depicted, remote computer system 102, responsive to a determination that the user is allowed to make the request, establishes the desktop sharing session with the local computer system 101 (step 410). As depicted, remote computer system 102 identifies a set of visible links in the visual output of the desktop and in the open applications on desktop environment 183 (step 415). As depicted, for each link 161 in the set of visible links, remote computer system 102 identifies a set of link attributes 163 (step 420). In this illustrative example, remote tool 151 on remote computer system 102 identifies links 145 and attributes 147. As depicted, remote computer system 102 communicates the set of link attributes 163 for each link 161 in the set of visible links 145 to the user's desktop sharing tool 131 on local computer system 101, i.e., pushes link attributes 163 to local computer system 101 or local computer 101 pulls attributes 163 from remote computer system 102 (step 425).

As depicted at step 430, remote computer system 102 receives a command from the user's desktop sharing tool 131 to modify link attributes 183 of link 161 executed on the local computer system 101 of the user for displaying the link as executed on remote desktop environment 167. As depicted, remote computer system 102 modifies link attributes 163 of link 161 executed on local computer system 101 to reflect a change in state of the link executed (step 435). As depicted, remote computer system 102 displays the change in state on desktop environment 167 of remote computer system 102 to reflect a change in state of the link executed (step 435). As depicted, local computer system 101 displays the change in state on desktop environment 167 and stores in memory, such as, for example, cache 159. As depicted, remote computer system 102 sends an updated graphical snapshot of desktop environment 167 of remote computer system 102 using the desktop sharing session, wherein the updated graphical snapshot shows the change in state of link 161 executed on the local computer system 101 (step 445). In step 450, as depicted, the user can terminate the desktop sharing session. If the user terminates the session, as depicted, remote computer system 102 receives a command to terminate the desktop sharing session, ending the process (step 455). If the user does not terminate the session, as depicted, the process returns to step 415.

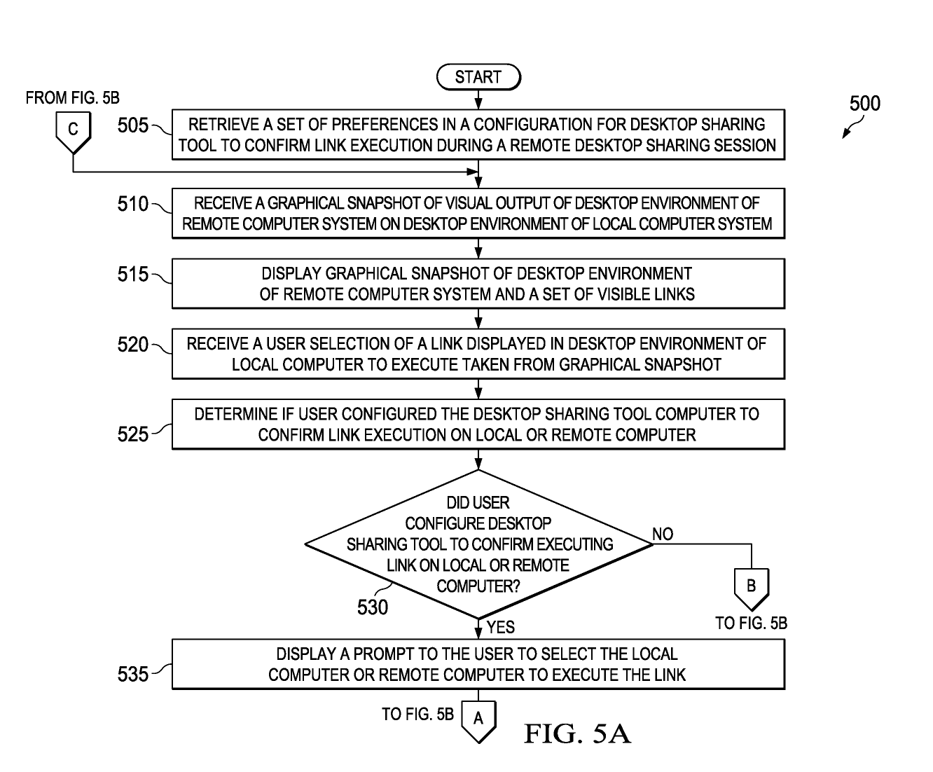

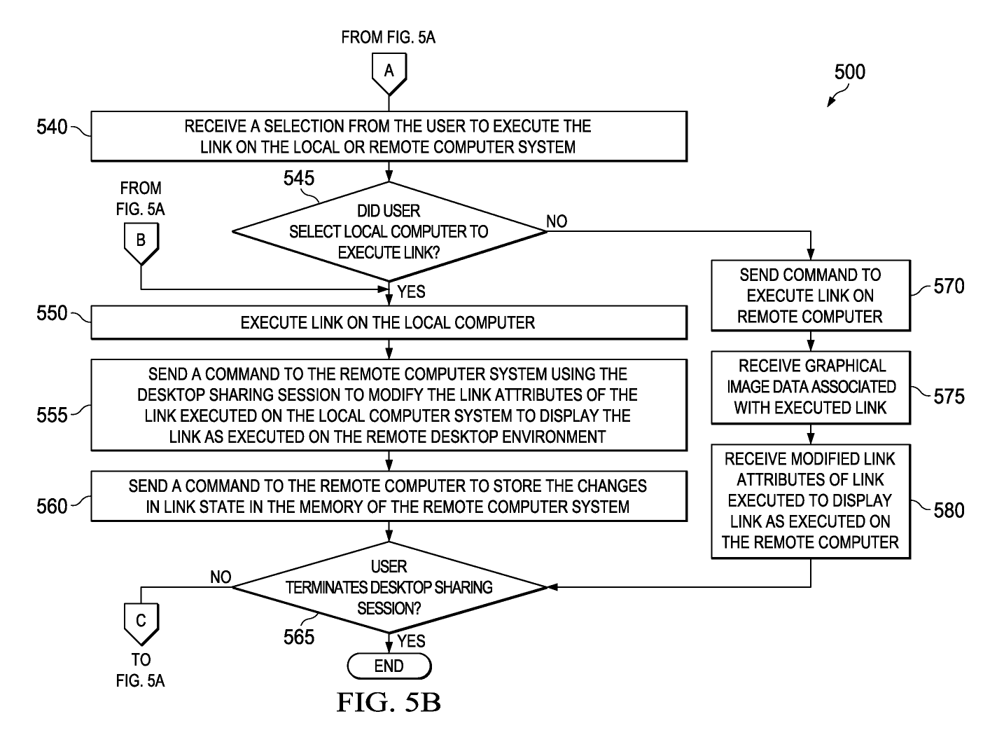

FIG. 5 depicts an illustration of a flowchart of an action confirmation process implemented during a desktop sharing session on a local computer system in accordance with an illustrative embodiment. It should be appreciated that FIG. 5 is only provided as an illustration of one implementation and is not intended to imply any limitation with regard to the an action confirmation process implemented during a desktop sharing session on a local computer system in which different embodiments may be implemented. Many modifications to the depicted action confirmation process may be made.

As depicted, action confirmation process implemented during a desktop sharing session on a local computer system 500 can be implemented as desktop sharing tool 131 on FIG. 1. With references to elements in FIG. 1, as depicted, the process begins with local computer system 101 retrieving a set of preferences in a configuration 137 for the desktop sharing tool 131 to confirm link execution during a remote desktop sharing session (step 505). As depicted, local computer system 101 receives a graphical snapshot of the visual output of the desktop environment 167 of the remote computer system 102 on the desktop environment 107 of the local computer system 101 (step 510). As depicted, local computer system 101 displays the graphical snapshot of the desktop environment of the remote computer system 102 and a set of visible links 145 (step 515). As depicted, local computer system 101 receives a user selection of a link 161 displayed in desktop environment 107 of local computer system 101 to execute taken from the graphical snapshot (step 520). As depicted, local computer system 101 determines if the user configured the desktop sharing tool 131 to confirm link execution on local computer system 101 or remote computer system 102 (step 525).

As depicted at step 530, the process determines what action to perform next. If the user configured desktop sharing tool 131 to confirm executing a link on either local computer system 101 or remote computer system 102, then the local computer system 101 displays a prompt to the user to select local computer system 101 or remote computer system 102 to execute link 161 (step 535). As depicted, local computer system 101 receives a selection from the user to execute link 161 on the local or remote computer system (step 540). As depicted at step 545, the process determines what action to take next. If the user selects local computer system 101 to execute link 161, local computer system 101 executes link 161 on local computer system 101 (step 550). Returning to step 530, as depicted, if the user does not configure desktop sharing tool 131 to confirm executing a link on either local computer system 101 or remote computer system 102, then the process also proceeds to step 550.

As depicted, after step 550, local computer system 101 sends a command to remote computer system 102 using the desktop sharing session to modify link attributes 163 of link 161 executed on the local computer system to display link 161 as executed on remote desktop environment 167 (step 555), and local computer system 101 sends a command to remote computer system 101 to store the changes in link state in the memory, e.g., cache 159 of remote computer system 102 (step 560). As depicted in step 565, the user can terminate the desktop sharing session. If the user terminates the session, as depicted, the process ends. If the user does not terminate the session, as depicted, the process returns to step 510.

Returning to step 545, as depicted, if the user did not select local computer system 101 to execute link 161, local computer system 101 sends a command to execute link 161 on remote computer system 102 (step 570). As depicted, local computer system 101 receives a graphical image data associated with executed link 161 (step 575). As depicted, local computer system 101 receives modified link attributes 163 of link 161 executed to display link 161 as executed on remote computer system 102 (step 580). As depicted, the process then proceeds to step 565.

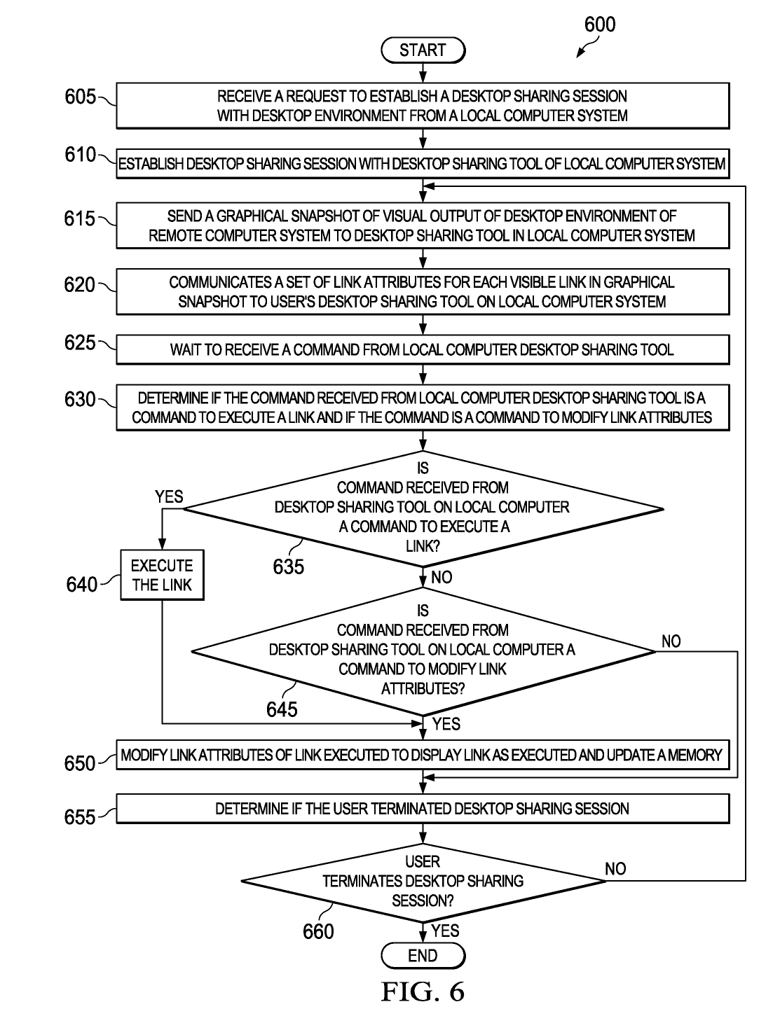

Turning to FIG. 6, an illustration of a flowchart of an action confirmation implemented during desktop sharing session on a remote computer system in accordance with an illustrative embodiment is depicted. It should be appreciated that FIG. 6 is only provided as an illustration of one implementation and is not intended to imply any limitation with regard to the an action confirmation process implemented during a desktop sharing session on a remote computer system in which different embodiments may be implemented. Many modifications to the depicted action confirmation process may be made.

As depicted, action confirmation process implemented during a desktop sharing session on a remote computer system 600 can be implemented as remote tool 151 on FIG. 1. With references to elements in FIG. 1, as depicted, the process begins with remote computer system 102 receiving a request to establish a desktop sharing session with desktop environment 107 a local computer system 101 (step 605). As depicted, remote computer system 102 establishes a desktop sharing session with desktop sharing tool 151 of local computer system 101. As depicted, remote computer system 102 sends a graphical snapshot of the visual output of desktop environment 167 of remote computer system 102 to desktop sharing tool 131 in local computer system 101 (step 615). As depicted, remote computer system 102 communicates a set of link attributes 163 for each visible link 161 in the graphical snapshot to the user's desktop sharing tool 131 on the local computer system 101 (step 620). In these illustrative examples, remote computer system 102 communicates link attributes 163 by remote computer system 102 pushing the attributes 163 to local computer system 101, or local computer system 101 pulls the attributes 163. As depicted in step 625, remote computer system 102 waits to receive a command from local computer desktop sharing tool 131.

As depicted, local computer system 101 determines if the command received from the local computer desktop sharing tool 131 is a command to execute link 161 and if the command is a command to modify link attributes 163 (step 630). In step 635, as depicted, if the command received from the desktop sharing tool 131 on the local computer system 101 is a command to execute link 161, remote computer system 102 executes link 161, the proceeding to step 650 (step 640). As depicted in step 635, if the command received from the desktop sharing tool 131 on the local computer system 101 is not a command to execute link 161, the process bypasses step 640 and proceeds to step 645. As depicted in step 645, if the command received from the desktop sharing tool 131 on local computer system 101 is a command to modify link attributes 163, remote computer system 102 modifies the link attributes of the link executed to display the link as executed and update a memory, e.g., cache 159 (step 650). Also, as depicted, if remote computer system 102 executes link 161 (step 640), the remote computer system 102 modifies the link attributes of the link executed to display the link as executed and update a memory, e.g., cache 159 (step 650). In another illustrative example, a command received at step 620 can comprise a command to both open link 161 and modify link attributes. In that illustrative example, step 635 may go to step 640 and then 645.

After step 650, as depicted, remote computer system 102 determines if the user terminated the desktop sharing session (step 655). As depicted in step 645, if the command received from the desktop sharing tool 131 on local computer system 101 is not a command to modify link attributes 163, the process proceeds to step 655. In this illustrative example, the command received by remote computer system 102 can comprise a terminate command. As depicted, if the user terminates the desktop sharing session, the process ends, and if the user does not terminate the desktop sharing session, the process returns to step 615 and continues (step 660).

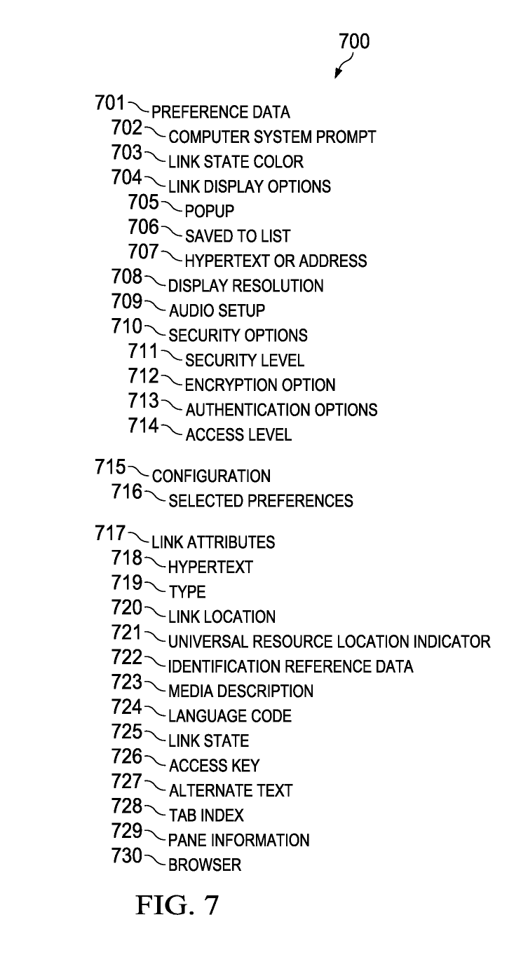

FIG. 7 depicts an illustration of a data structure used by a desktop sharing tool during a desktop sharing session in accordance with an illustrative embodiment. It should be appreciated that FIG. 7 is only provided as an illustration of one implementation and is not intended to imply any limitation with regard to a data structure used during a desktop sharing session in which different embodiments may be implemented. Many modifications to the data structure may be made.

As depicted, data structure in remote sharing tool action 700 represents a data structure implemented on local computer system 101 in FIG. 1 and may be used by desktop sharing tool 131. As depicted, preference data 701 comprises computer system prompt 702, link state color 703, link display options 704, display resolution 708, audio setup 709, and security options 710. In these illustrative examples, computer system prompt 702 sets a preference for whether the user opens a selected link on the local computer system 101 or the remote computer system 102. In these illustrative examples, link state color 703 can set a desired color for graphically displaying executed links 161 or 145 on desktop environment 107. Similarly, in these illustrative examples, link options 704 can be set from choices selected from a list comprising a popup option 705, a saved list option 706, and a hypertext or address option 707. In these illustrative examples, if the user selects popup 705, local computer system 101 display visible links 161 in popup 141. In these illustrative examples, if the user selects saved to list 706, local computer system 101 saves visible links 161 in cache 139, which may further comprise links 147 in a set of window 109. In these illustrative examples, the user can select to display links 161 as hypertext, such as for example <link> or http://www.link/here/html or an address, such as for example, 123.45.67.8. In these illustrative examples, display resolution 708 can comprise a pixel resolution or color resolution on local computer system 101. In these illustrative examples, audio setup 709 can comprise, for example, a sound volume, sound quality, or mono or stereo choices. In these illustrative examples, security options 710 can comprise, for example, a user selected security level 711, which may involve setting an authentication or an encryption protocol, encryption options 712, in which a user may select from several available options or levels of encryption for the desktop sharing session, authentication options 713, in which a user may select from several available authentication options to confirm identification for access, and access level 714, in which a user may have several levels of access permitted on remote computer 102, such as for example, an access level 714 permitting modifying application files, an access level blocking any modification to files, or an access level blocking modifying operating system setting, or any other desired option.

As depicted, configuration 715 comprises selected preferences 716. In these illustrative examples, selected preferences 716 can comprise one or more preference data 701 set by a user. As depicted, preference data 701 comprises prompt 702, link state color 703, link display options 704, display resolution 708, audio setup 709, and security options 710, and these can comprise settings for configuration 715.

As depicted, link attributes 717 comprises hyperlink 718, type 719, link location 720, universal resource location indicator 721, identification reference data 722, media description 723, language code 724, link state 725, access key 726, alternate text 727, tab index 728, pane information 729, and browser 730, and are examples of attributes 147.

In these illustrative examples, hypertext 718 can comprise hypertext, text, pictograms or icons, buttons, pictures, or other graphical presentations linking to a designated location. Hypertext 718 can also be said to comprise a hotspot on a graphical presentation linked to an address or location. In these illustrative examples, type 719 can comprise what the link opens. For example, the link 719 can comprise a hypertext transfer protocol type link opening a webpage, multimedia type opening to a multimedia application, or a document file type requiring a specific word processor application, or any other applicable type of hyperlink. In these illustrative examples, link location 720 can comprise, for example, a file location on a network server, a file name on remote computer system 102, an Internet address, or other location data. In these illustrative examples, universal resource location indicator 721 indicates a specific location on the Internet, which hypertext 718 opens to when accessed. In these illustrative examples, identification reference data 722 provides a unique identifier for an element within a document opened at location 720 and by universal resource location indicator 721 and can be used to create link 161 to the particular element.

In these illustrative examples, media description 723 designates the media for which the linked resource is designed. For example, media description can specify screen for non-paged computer displays, television for television devices, aural for speech devices, braille for tactile feedback devices, and handheld for handheld devices. In these illustrative examples, language code 724 specifies a language used, and can, for example, enable specific language character sets such as Japanese, Chinese, Russian, or Greek, which use non-English character sets. In these illustrative examples, link state 725 reflects whether hypertext 718 has been accessed or not. In these illustrative examples, access key 726 defines a keystroke or other input, e.g., a click, that opens the link. In these illustrative examples, alternate text 727 comprises textual data for a hypertext 718, such as for example replacing a hyperlink picture with a hypertext depiction on desktop environment 107 in FIG. 1. In these illustrative examples, tab index 728 specifies a tabbing order used when multiple links 145 appear onscreen. Typically, when multiple links appear, the user can press “tab” to cycle between links 145, then press “enter” to open link 145. Using tab index 728, attributes 147 specify the tabbing order. In these illustrative examples, pane information 729 can comprise pixel height and width for link 147 when opened. In these illustrative examples, browser 730 can specify a browser to open. For example, browser 730 can indicate which bowser pane to open in a multimedia player, such as for example in RealOne Player®, Windows Media Player®, or Apple QuickTime®. As another example, browser 730 can specify Google Chrome®, Windows Internet Explorer®, Opera®, or Mozilla Firefox®. In yet another example, browser can specify an email browser pane such as Microsoft Outlook®, Google Gmail®, Yahoo Mail®, or Opera®.

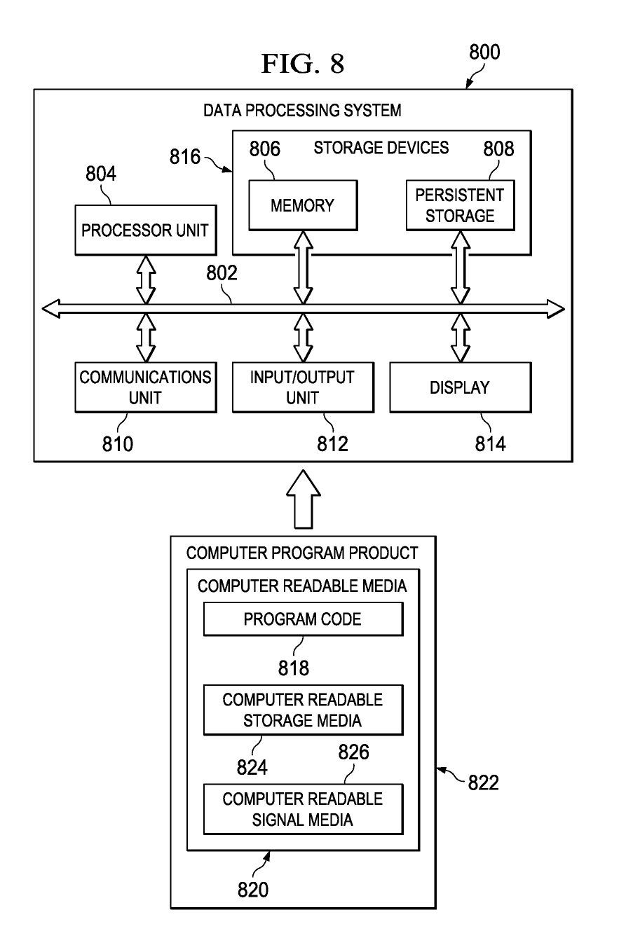

Turning now to FIG. 8, an illustration of a data processing system is depicted in accordance with an advantageous embodiment. Data processing system 800 may be used to implement local computer system 101 and remote computer system 102 in FIG. 1. In this illustrative example, data processing system 800 includes communications framework 802, which provides communications between processor unit 804, memory 806, persistent storage 808, communications unit 810, input/output (I/O) unit 812, and display 814. In this example, communication framework may take the form of a bus system.

Processor unit 804 serves to execute instructions for software that may be loaded into memory 806. Processor unit 804 may be a number of processors, a multi-processor core, or some other type of processor, depending on the particular implementation.

Memory 806 and persistent storage 808 are examples of storage devices 816. A storage device is any piece of hardware that is capable of storing information, such as, for example, without limitation, data, program code in functional form, and/or other suitable information either on a temporary basis and/or a permanent basis. Storage devices 816 may also be referred to as computer readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through a keyboard, a mouse, and/or some other suitable input device. Further, input/output unit 812 may send output to a printer. Display 814 provides a mechanism to display information to a user.

Instructions for the operating system, applications, and/or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer usable program code, or computer readable program code that may be read and executed by a processor in processor unit 804. The program code in the different embodiments may be embodied on different physical or computer readable storage media, such as memory 806 or persistent storage 808.

Program code 818 is located in a functional form on computer readable media 820 that is selectively removable and may be loaded onto or transferred to data processing system 800 for execution by processor unit 804. Program code 818 and computer readable media 820 form computer program product 822 in these illustrative examples. In one example, computer readable media 820 may be computer readable storage media 824 or computer readable signal media 826.

In these illustrative examples, computer readable storage media 824 is a physical or tangible storage device used to store program code 818 rather than a medium that propagates or transmits program code 818.

Alternatively, program code 818 may be transferred to data processing system 800 using computer readable signal media 826. Computer readable signal media 826 may be, for example, a propagated data signal containing program code 818. For example, computer readable signal media 826 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 800 are not meant to provide architectural limitations to the manner in which different embodiments may be implemented. The different advantageous embodiments may be implemented in a data processing system including components in addition to and/or in place of those illustrated for data processing system 800. Other components shown in FIG. 8 can be varied from the illustrative examples shown. The different embodiments may be implemented using any hardware device or system capable of running program code 818. Additionally, as used herein, and in accordance with an illustrative example, processor unit 804 can comprise a distributed processor unit 804 with a portion implemented on local computer system 101 and a portion on remote computer 102.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing content displayed in a remote data processing system, the method comprising:
identifying, by a processor unit, a set of links displayed in the content of the remote data processing system during a desktop sharing session between a local data processing system and the remote data processing system;
obtaining, by the processor unit, information about the set of links identified; and
responsive to a selection of a link in the set of links displayed on the remote data processing system during the desktop sharing session, retrieving content, by the processor unit, using the link on the local data processing system using the information obtained about the set of links.

2. The method of claim 1, wherein obtaining, by the processor unit, further comprises one of:
a push of information, by the remote data processing system, about the set of links identified; and
a pull of information, by the local data processing system, about the set of links identified.

3. The method of claim 1, wherein the processor unit comprises a distributed processor unit with a portion on the local data processing system and a portion on the remote data processing system.

4. The method of claim 1, wherein retrieving content, by the processor unit, comprises:
accessing the content at a link location indicated by the information; or
saving information on the selected link comprising a link location in a cache.

5. The method of claim 1, wherein the set of links displayed in the content of the remote data processing system comprises a visual data output from the remote data processing system and can be seen in an active window of the remote data processing system or seen anywhere in the visual data output.

6. The method of claim 5, wherein the link comprises a clickable area within the visual data output of the remote data system comprising at least one of:
a clickable icon;
a clickable button;
a clickable toolbar;
a clickable picture; and
a clickable alphanumeric text.

7. The method of claim 1, wherein retrieving content on the local data processing system, by the processing unit, further comprises displaying a prompt to execute the link on the local data processing system or the remote data processing system.

8. The method of claim 7 further comprising:
responsive to a user input, executing, by the processor unit, the link on the remote data processing unit if selected, or executing, by the processor unit, the link on the local data processing unit if selected.

9. The method of claim 1, wherein obtaining, by the processor unit, further comprises displaying the set of links in a popup window on the local processing system.

10. A computer program product for managing content displayed in a remote data processing system, the computer program product comprising:
a computer readable storage medium;
program code, stored on the computer readable storage medium, for identifying, by a processor unit, a set of links displayed in the content of the remote data processing system during a desktop sharing session between a local data processing system and the remote data processing system;
program code, stored on the computer readable storage medium, for obtaining information about the set of links identified; and
program code, stored on the computer readable storage medium, responsive to a selection of a link in the set of links displayed on the remote data processing system during the desktop sharing session, for retrieving content using the link on the local data processing system using the information obtained about the set of links.

11. The computer program product of claim 10, wherein obtaining further comprises one of:
program code, stored on the computer readable storage medium, for pushing information, by the remote data processing system, about the set of links identified; and
program code, stored on the computer readable storage medium, for pulling information, by the local data processing system, about the set of links identified.

12. The computer program product of claim 10, wherein retrieving content further comprises:
program code, stored on the computer readable storage medium, for accessing the content at a link location indicated by the information; or
program code, stored on the computer readable storage medium, for saving information on the selected link comprising a link location in a cache.

13. The computer program product of claim 10, wherein obtaining information about the set of links identified on the local data processing system further comprises:
program code, stored on the computer readable storage medium, for displaying a prompt to execute the link on the local data processing system or the remote data processing system.

14. The method of claim 13 further comprising:
program code, stored on the computer readable storage medium, responsive to a user input, executing the link on the remote data processing unit if selected, or executing the link on the local data processing unit if selected.

15. The method of claim 10, wherein obtaining further comprises:
program code, stored on the computer readable storage medium, for displaying the set of links in a popup window on the local processing system.

16. A data processing system for managing content displayed in a remote data processing system, the system comprising:
a bus system;
a storage device connected to the bus system, wherein the storage device includes program code;
a processor unit configured to execute the program code to identify a set of links displayed in the content of the remote data processing system during a desktop sharing session between a local data processing system and the remote data processing system; obtain information about the set of links identified; and responsive to a selection of a link in the set of links displayed on the remote data processing system during the desktop sharing session, retrieving content using the link on the local data processing system by using the information obtained about the set of links.

17. The data processing system of claim 16, wherein obtaining further comprises one of:
pushing information, by the remote data processing system, about the set of links identified; and
pull information, by the local data processing system, about the set of links identified.

18. The data processing system of claim 16, wherein the processor unit comprises a distributed processor unit with a portion on the local data processing system and a portion on the remote data processing system.

19. The data processing system of claim 16, wherein retrieving content by the processor unit further comprises:
accessing the content at a link location indicated by the information; or
saving information on the selected link comprising a link location in a cache.

20. The data processing system of claim 16, wherein obtaining information about the set of links identified on the local data processing system further comprises:
displaying a prompt to execute the link on the local data processing system or the remote data processing system.
